(19) United States
(12) Patent Application Publication
(10) Pub. No.: US 2013/0098976 A1
(43) Pub. Date: Apr. 25, 2013

(54) METHOD FOR FORMING ELECTRICAL CONNECTOR

(71) Applicants: Chao Wen Cai, Guangzhou (CN); Yong Quan Wu, Guangzhou (CN)

(72) Inventors: Chao Wen Cai, Guangzhou (CN); Yong Quan Wu, Guangzhou (CN)

(73) Assignee: LOTES CO., LTD., Keelung (TW)

(21) Appl. No.: 13/399,049

(22) Filed: Feb. 17, 2012

(30) Foreign Application Priority Data
Oct. 19, 2011 (CN) 201110317709.0

(51) Int. Cl. B23K 1/20

(52) U.S. Cl. 228/256

(57) ABSTRACT

A method for forming an electrical connector. In one embodiment, the method includes: providing a body, where a plurality of terminals are fixed in the body, each terminal has an extending portion exposed downwardly out of the body, and a soldering portion disposed at one end of the extending portion; providing a flat working surface and a plurality of solder materials, and placing the body above the flat working surface, so that the solder material is connected upwardly to the soldering portion, and connected downwardly to the flat working surface; heating the solder material, and then cooling and solidifying the solder material, so that the solder material is fixed to the soldering portion; and removing the flat working surface.

### CROSS-REFERENCE TO RELATED APPLICATION

This non-provisional application claims priority under 35 U.S.C. §119(a) on Patent Application No. 201110317709.0 filed in P.R. China on Oct. 19, 2011, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates to a method for forming an electrical connector, and more particularly to a method for forming an electrical connector having a solder material disposed therein.

### BACKGROUND OF THE INVENTION

An electrical connector is a bridge for electrical connection between an electronic component and a circuit board. To ensure that an electrical connector can be desirably soldered onto a circuit board, a common method in this field is using solder balls to enhance the soldering effect, and the solder balls may generally be fixed in the electrical connector by pre-soldering or clamping.

A conventional electrical connector includes a body having a plurality of receiving holes, a plurality of terminals fixed in the receiving holes, and a plurality of solder balls correspondingly fixed in the receiving holes and respectively contacting the terminals. The clamping manner is using an inner wall of the receiving hole and the terminal to jointly clamp the solder ball, or using a structure disposed on the terminal to clamp the solder ball. The pre-soldering manner is heating the solder ball first, and then connecting the solder ball to the terminal.

However, for the manner of using the inner wall of the receiving hole and the terminal to jointly clamp the solder ball, when the electrical connector is soldered onto the circuit board, the electrical connector needs to be heated, and thus the solder ball undergoes thermal expansion, and extrudes the inner wall of the receiving hole, causing deformation of the body. For the manner of using a structure disposed on the terminal to clamp the solder ball, a complex design of the terminal is required to clamp the solder ball, leading to a high cost. For the manner of pre-soldering the solder ball onto the terminal, high-temperature heating to the melting point of the solder ball or higher is required for the pre-soldering process. When the electrical connector is soldered to the circuit board, another heating operation to the melting point of the solder ball or higher is required, thus the body is greatly affected, and is easily warped and deformed.

In addition, as disclosed in Chinese Patent No. CN200610055042.0, where a method for forming electrical contacts of terminals of an electrical connector receptacle, includes the following steps in sequence:

1. First, a bottom end of a receptacle body of an electrical connector is placed upwardly for placing a solder paste hole plate. The solder paste hole plate is placed above the receptacle body of the electrical connector, and solder paste holes of the solder paste hole plate are respectively corresponding to central positions of end surfaces of connecting ends of terminals in slots of the receptacle body.

2. Coating a solder paste: coating a suitable amount of solder paste to a side edge of the solder paste hole plate.

3. Scraping the solder paste: using a scraper to scrape from the side edge of the solder paste hole plate that is coated with the solder paste to an opposite side edge, so that a part of solder paste fills in the solder paste holes through movement of the scraper, and forms solder paste blocks at the central positions of the end surfaces of the connecting ends of the terminals.

4. Removing the solder paste hole plate: separating the solder paste hole plate from the receptacle, with the solder paste blocks being located at the central positions of the end surfaces of the connecting ends of the terminals.

5. Heating: heating the receptacle body having the solder paste blocks.

6. Forming solder joints: the heated solder paste blocks coagulate due to cohesion to form electrical contacts.

The solder paste in the electrical connector receptacle is fixed to the connecting end of the terminal by heating, which eliminates the effect of thermal expansion of the solder ball on the body when the inner wall of the receiving hole and the terminal are used to jointly clamp the solder ball, and does not require the terminal to have a complex structural design to clamp the solder ball, so that the cost is saved.

However, in the above method, as the bottom end of the receptacle body of the electrical connector is placed upwardly, and the solder paste is located on the connecting end of the terminal, the solder paste flows downwardly under the gravity when the solder paste is heated. As the solder paste hole plate is removed before heating, the flatness of the electrical contacts after heating cannot be ensured. As a result, when the electrical connector receptacle is soldered to the circuit board, missing solder or false soldering may occur.

Therefore, a heretofore unaddressed need exists in the art to address the aforementioned deficiencies and inadequacies.

### SUMMARY OF THE INVENTION

In one aspect, the present invention is directed to a method for forming an electrical connector, which can ensure coplanarity at the bottom of the solder material.

In one embodiment, a method for forming an electrical connector according to the present invention includes: providing a body, where a plurality of terminals are fixed in the body, each terminal has an extending portion exposed downwardly out of the body, and a soldering portion is disposed at one end of the extending portion; providing a flat working surface and a plurality of solder materials, and placing the body above the flat working surface, so that the solder material is connected upwardly to the soldering portion, and connected downwardly to the flat working surface; heating the solder material, and then cooling and solidifying the solder material, so that the solder material is fixed to the soldering portion; and removing the flat working surface.

As compared with the related art, in one aspect of the method for forming an electrical connector of the present invention, a flat working surface is disposed on a bottom surface of the solder material, and the flat working surface is removed after the solder material is fixed to the soldering portion, so that the flatness of the bottom of the solder material can be ensured, thereby preventing missing solder or false soldering from occurring when the electrical connector is soldered to a circuit board.

Further, when the solder material is heated, if a heating temperature reaches a melting point of the solder material, the solder material changes to a spherical shape after cooling and solidifying. When the solder material is heated, if a heating temperature exceeds a melting point of the solder material, the solder material changes to a spherical shape after cooling and solidifying. When the solder material is heated, if a heating temperature is lower than a melting point of the solder material, the solder material maintains an original shape after cooling and solidifying. In one embodiment, the solder material is a solder paste. Alternatively, the solder material is a solder ball. The soldering portion may have a hook located in the solder material. In one embodiment, a solder mask material is disposed on the flat working surface. Alternatively, the flat working surface is made of a solder mask material. The solder material has a thickness of greater than 0.2 mm. In one embodiment, a plurality of accommodating holes are disposed on the flat working surface corresponding to the solder materials, and the solder material is located in the accommodating hole. The soldering portion is inserted downwardly into the solder material. In one embodiment, the soldering portion is bent, and the solder material is located on a bottom surface of the soldering portion. In one embodiment, before the solder material is connected to the soldering portion, the solder material is disposed on the flat working surface. Alternatively, before the solder material is connected to the soldering portion, the solder material is disposed on the soldering portion.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a flowchart of a method for forming an electrical connector according to one embodiment of the present invention;

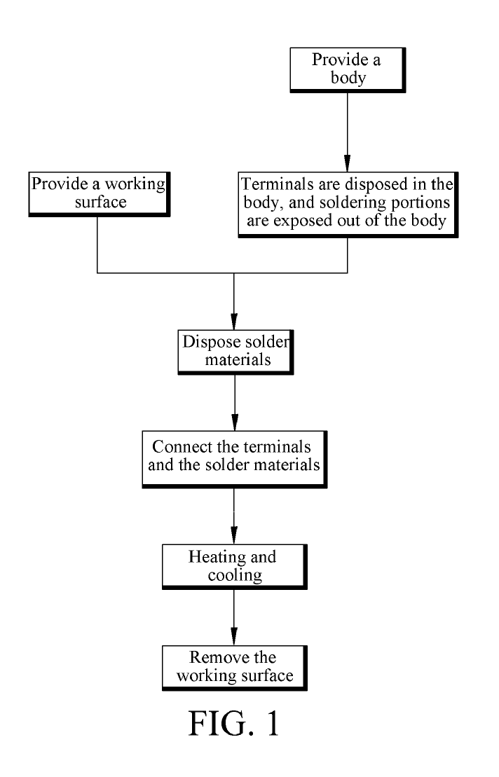

FIG. 2 is a schematic view of disposing solder materials on a working surface in the method for forming an electrical connector according to one embodiment of the present invention;

FIG. 3 is a schematic view of connecting terminals to solder materials in the method for forming an electrical connector according to one embodiment of the present invention;

FIG. 4 is a schematic view of a formed electrical connector and a flat working surface before being separated in the method for forming an electrical connector according to one embodiment of the present invention;

FIG. 5 is a schematic view of a formed electrical connector in the method for forming an electrical connector according to one embodiment of the present invention;

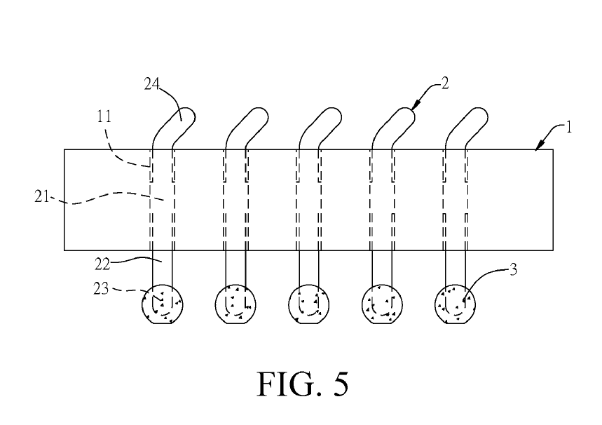

FIG. 6 is a schematic view of disposing solder materials in accommodating holes of a flat working surface in the method for forming an electrical connector according to one embodiment of the present invention;

FIG. 7 a schematic view of disposing solder materials on terminals first in another embodiment of the method for forming an electrical connector of the present invention;

FIG. 8 a schematic view of flattening solder materials by using a flat working surface in another embodiment of the method for forming an electrical connector of the present invention; and

FIG. 9 is a schematic view of a formed electrical connector in another embodiment of the method for forming an electrical connector of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

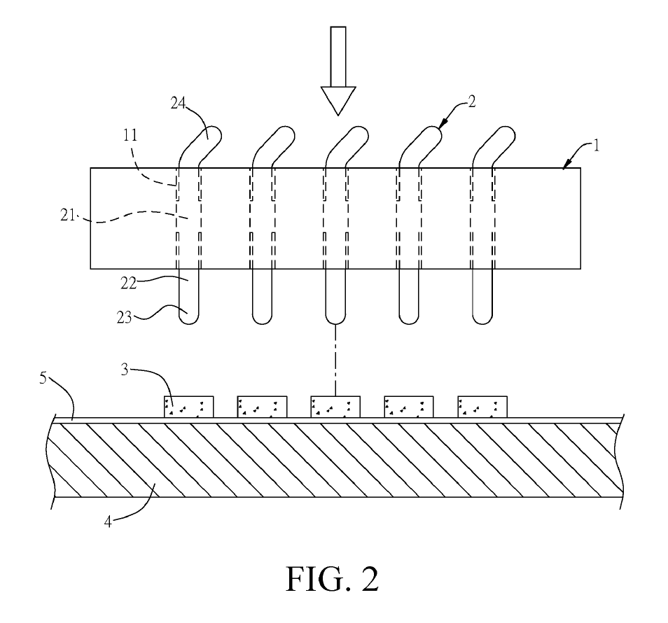

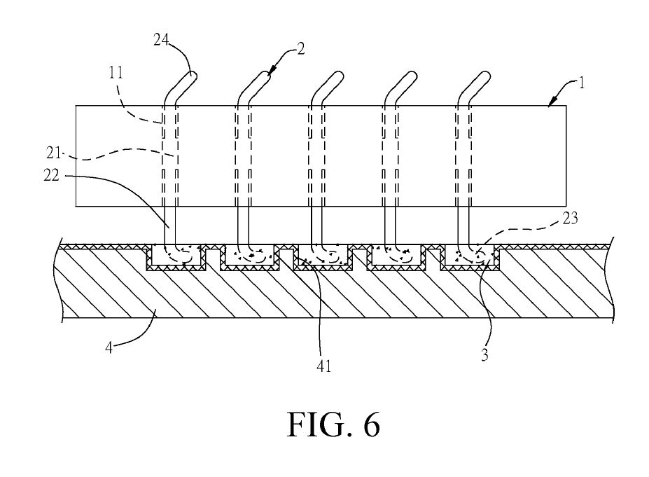

Referring to FIG. 2 and FIG. 6, an electrical connector according to one embodiment of the present invention includes: a body 1, the body 1 having a plurality of receiving holes 11, and a plurality of terminals 2, respectively fixed in the receiving holes 11. Each terminal 2 has a fixing portion 21 fixed in the receiving hole 11. An extending portion 22 extending downwardly from the fixing portion 21 and exposed downwardly out of the receiving hole 11. A soldering portion 23 disposed at one end of the extending portion 22, and a contact portion 24 extending upwardly from the fixing portion 21 and exposed upwardly out of the receiving hole 11. The soldering portion 23 vertically extends downwardly. Alternatively, in other embodiments, the soldering portion 23 may be bent.

The electrical connector is used for being electrically mounted to a circuit board (not shown). To ensure a stable soldering effect between the soldering portions 23 and the circuit board (not shown), a plurality of solder materials 3 are disposed between the terminals 2 and the circuit board (not shown). The solder materials 3 are solder pastes in this embodiment, and may be solder balls or solder blocks in other embodiments.

Referring to FIG. 2 and FIG. 6, the solder pastes are placed on an upper surface of a flat working surface 4. Alternatively, in other embodiments, a plurality of accommodating holes 41 is disposed in the upper surface of the flat working surface 4 corresponding to the solder pastes, and the solder paste is located in the accommodating hole 41. A solder mask material 5 is disposed on the upper surface of the flat working surface 4. Alternatively, in other embodiments, the flat working surface 4 is made of a solder mask material. The solder mask material 5 mainly includes a polymer resin mortar, a film-forming resin and the like. Products made of solder mask materials may include a solder mask agent, a solder mask glue and a solder mask paste. The solder paste is located on the solder mask material 5. The solder paste has a thickness of 0.2 mm. Alternatively, in other embodiments, the solder paste may have a thickness of greater than 0.2 mm.

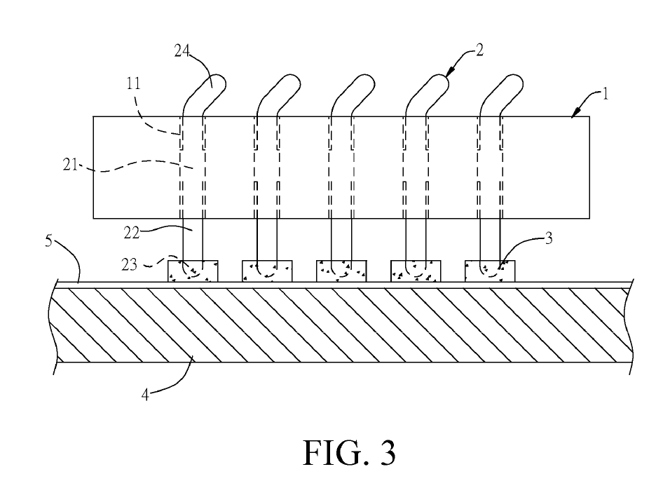

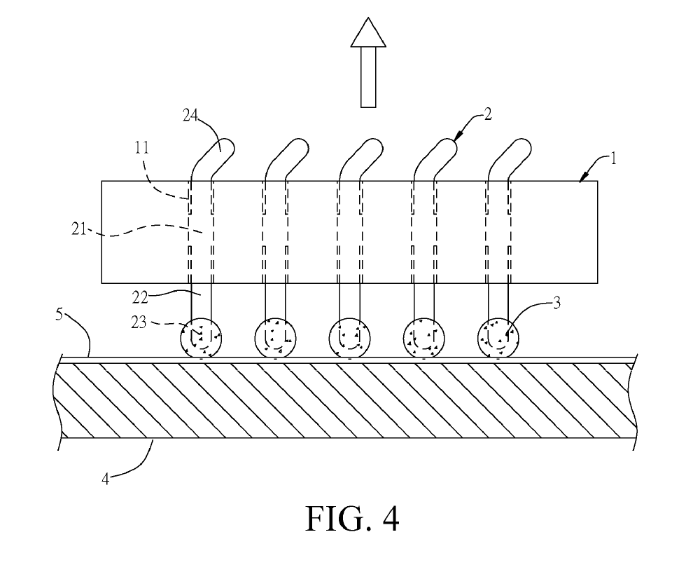

Referring to FIGS. 2-4, to form the electrical connector, the terminals 2 are correspondingly inserted and fixed in the receiving holes 11, so that the extending portion 22 is exposed downwardly out of the receiving hole 11. Meanwhile, the flat working surface 4 may be provided, where the solder mask material 5 is disposed on the upper surface of the flat working surface 4. Then the solder pastes are disposed on the solder mask material 5. Alternatively, in other embodiments, the terminals 2 located in the receiving holes 11 are fabricated first, and then the solder pastes located on the upper surface of the flat working surface 4 are fabricated. Alternatively, the solder pastes located on the upper surface of the flat working surface 4 are fabricated first, and then the terminals 2 located in the receiving holes 11 are fabricated.

When the accommodating holes 41 are disposed on the flat working surface 4, the accommodating holes 41 are opened on the upper surface of the flat working surface 4 first. The solder mask material 5 is subsequently disposed on the upper surface of the flat working surface 4 and inner walls of the accommodating holes 41. Then the solder pastes are disposed in the accommodating holes 41. The accommodating holes 41 are disposed on the flat working surface 4 so as to ensure that a sufficient amount of the solder paste is in contact with the soldering portion 23.

Next, the body 1 is placed above the flat working surface 4. If the soldering portion 23 is vertically extended downwardly, the soldering portion 23 is directly inserted downwardly into the solder paste. Alternatively, if the soldering portion 23 is bent, the soldering portion 23 is enabled to urge against the solder paste.

Afterward, the above structure is heated, where the heating manner may be subjecting the flat working surface 4 to thermal treatment, or placing the entire structure into a reflow oven for heating, so that the solder paste is also heated. Then the above structure is cooled and solidified, so that the solder paste is fixed to the soldering portion 23.

When the solder paste is heated, if the heating temperature reaches the melting point of the solder paste, the solder paste changes to a spherical shape after cooling and solidifying. When the solder paste is heated, if the heating temperature exceeds the melting point of the solder paste, the solder paste changes to a spherical shape after cooling and solidifying. Alternatively, in other embodiments, when the solder paste is heated, if the heating temperature is lower than the melting point of the solder paste, the solder paste maintains an original shape after cooling and solidifying. The solder paste is melted by heating, and the solder paste attaches to a surface of the soldering portion 23 of the terminal 2 due to cohesion of the solder paste. After cooling and solidifying, the solder paste is fixedly connected to the soldering portion 23.

Finally, the flat working surface 4 is removed.

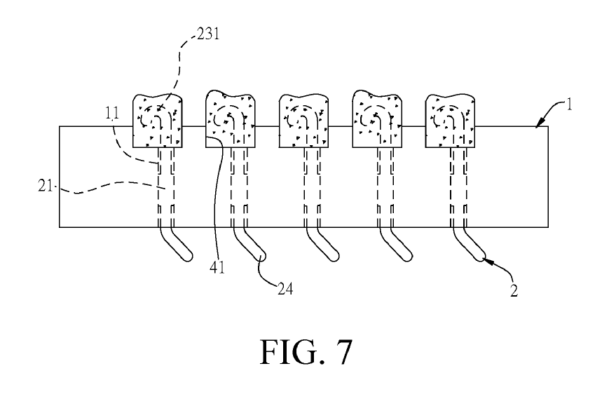

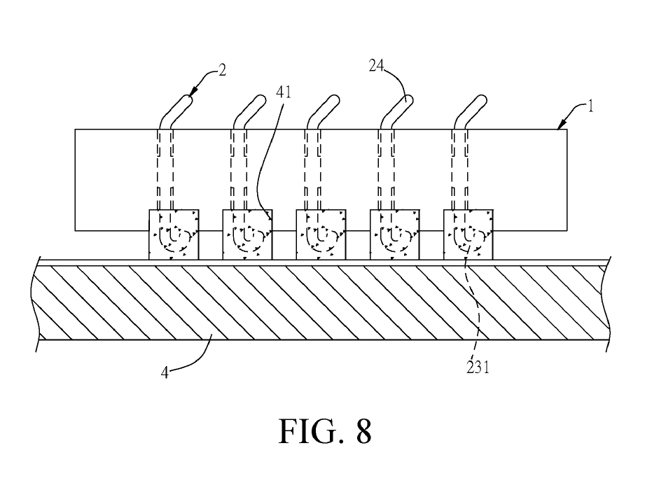

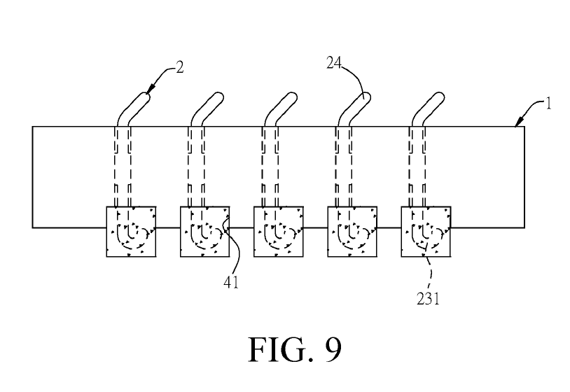

Referring to FIGS. 7-9, in another embodiment, each of the terminal 2 is respectively inserted and fixed in a corresponding receiving hole 11, so that the extending portion 22 is exposed downwardly out of the receiving hole 11. The soldering portion 23 is disposed at one end of the extending portion 22. The soldering portion 23 has a hook 231, where the soldering portion 23 may extend downwardly first and then be bent upwardly and extend to form the hook 231. Alternatively, a recessed portion may be disposed in the soldering portion 23, and a plurality of grooves 12 is disposed in the body 1 corresponding to the terminals 2. Then, the solder pastes are disposed. In this embodiment, as the solder paste needs to be disposed on the soldering portion 23, the body 1 is overturned so that the soldering portion 23 is located above the body 1, and then the solder paste is coated on the soldering portion 23, so that the solder paste is at least partially inserted into the soldering portion 23. Then, the body 1 is overturned so that the soldering portion 23 is located below the body 1. At this time, the flat working surface 4 is provided, where the flat working surface 4 is made of the solder mask material 5, and a bottom surface of the solder paste is placed above the flat working surface 4. The solder paste is heated to a temperature lower than the melding point of the solder paste, and then cooled and solidified, so that the solder paste is fixedly connected to the terminal 2, with the solder paste maintaining an original shape. The flat working surface 4 is removed.

Based on the above, the method for forming an electrical connector according to the embodiments of the present invention, among other things, has the following beneficial effects.

1. The flat working surface 4 is disposed under the bottom surface of the solder material 3, and the flat working surface 4 is removed after the solder material 3 is fixed to the soldering portion 23. Such a step can ensure the flatness of solder joints at the bottom of the solder paste, save the flattening step required when the solder material 3 is not flat in the related art, and prevent missing solder or false soldering from occurring when the electrical connector is soldered to the circuit board (not shown).

2. The hook 231 is disposed on the soldering portion 23. The solder material 3 fills in the hook 231 after the solder material 3 is cooled and solidified. When the terminal 2 and the flat working surface 4 are separated, the contact between the solder material 3 and the soldering portion 23 becomes firmer. In addition, in this process, the soldering portion 23 exerts an upward force on the solder material 3, so that the solder paste does not easily fall off, thereby improving the yield.

3. When the heating temperature does not exceed the melting point of the solder material 3, not only the solder material 3 can be fixedly connected to the soldering portion 23, but also the problem in the pre-soldering process that the body 1 suffers from a high temperature reaching or exceeding the melting point of the solder material 3 twice can be solved, thereby preventing warping and deformation of the body 1, and improving the product quality.

4. As the solder mask material 5 is disposed on the flat working surface 4, or the flat working surface 4 is made of the solder mask material 5, the success rate of separating the flat working surface 4 from the solder material 3 can be improved.

5. It is observed through experiments that, when the thickness of the solder paste is smaller than 0.2 mm, the solder paste after being heated can still attach to the surface of the terminal 2. However, due to the insufficient thickness, when the flat working surface 4 is removed, the adhesive force of the solder paste to the flat working surface 4 is greater than that to the surface of the terminal 2, and the terminal 2 is separated from the solder paste, resulting in that the amount of solder paste lifted up is too small to allow normal use of the electrical connector. Therefore, it is defined that the thickness of the solder paste should be greater than 0.2 mm. In this way, when the thickness of the solder material 3 is greater than 0.2 mm, the amount of the solder material 3 lifted up after heating, cooling and solidifying may reach the criterion allowing normal use of the electrical connector.

6. The accommodating holes 41 are disposed on the flat working surface 4 corresponding to the solder materials 3, so that more solder materials 3 can be disposed to ensure that a sufficient amount of the solder paste is in contact with the terminal 2, thereby enhancing the adhesion of the solder paste to the surface of the terminal 2.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for forming an electrical connector, comprising:
(a) providing a body, wherein a plurality of terminals are fixed in the body, each terminal has an extending portion exposed downwardly out of the body, and a soldering portion disposed at one end of the extending portion;
(b) providing a flat working surface;
(c) providing a plurality of solder materials, and placing the body above the flat working surface, so that the solder material is connected upwardly to the soldering portion, and connected downwardly to the flat working surface;
(d) heating the solder material, and then cooling and solidifying the solder material, so that the solder material is fixed to the soldering portion; and
(e) removing the flat working surface.

2. The method for forming an electrical connector according to claim 1, wherein when the solder material is heated, a heating temperature reaches a melting point of the solder material, and the solder material changes to a spherical shape after cooling and solidifying.

3. The method for forming an electrical connector according to claim 1, wherein when the solder material is heated, a heating temperature exceeds a melting point of the solder material, and the solder material changes to a spherical shape after cooling and solidifying.

4. The method for forming an electrical connector according to claim 1, wherein when the solder material is heated, a heating temperature is lower than a melting point of the solder material, and the solder material maintains an original shape after cooling and solidifying.

5. The method for forming an electrical connector according to claim 1, wherein the solder material is a solder paste.

6. The method for forming an electrical connector according to claim 1, wherein the solder material is a solder ball.

7. The method for forming an electrical connector according to claim 1, wherein the soldering portion has a hook located in the solder material.

8. The method for forming an electrical connector according to claim 1, wherein a solder mask material is disposed on the flat working surface.

9. The method for forming an electrical connector according to claim 1, wherein the flat working surface is made of a solder mask material.

10. The method for forming an electrical connector according to claim 1, wherein the solder material has a thickness of greater than 0.2 mm.

11. The method for forming an electrical connector according to claim 1, wherein a plurality of accommodating holes are disposed on the flat working surface corresponding to the solder materials, and the solder material is located in the accommodating hole.

12. The method for forming an electrical connector according to claim 1, wherein the soldering portion is inserted downwardly into the solder material.

13. The method for forming an electrical connector according to claim 1, wherein the soldering portion is bent, and the solder material is located on a bottom surface of the soldering portion.

14. The method for forming an electrical connector according to claim 1, wherein before the solder material is connected to the soldering portion, the solder material is disposed on the flat working surface.

15. The method for forming an electrical connector according to claim 1, wherein before the solder material is connected to the soldering portion, the solder material is disposed on the soldering portion.
